(19) United States
(12) Patent Application Publication
(10) Pub. No.: US 2014/0164995 A1
(43) Pub. Date: Jun. 12, 2014

(54) GRAPHICAL REPRESENTATION OF THRESHOLD OPERATIONS

(71) Applicants: Nishant Ghadge, Ulhasnagar (IN); Seshadri Chatterjee, Kolkata (IN)

(72) Inventors: Nishant Ghadge, Ulhasnagar (IN); Seshadri Chatterjee, Kolkata (IN)

(21) Appl. No.: 13/712,934

(22) Filed: Dec. 12, 2012

(51) Int. Cl. G06F 3/0482

(52) U.S. Cl. CPC G06F 3/0482
USPC 715/810

(57) ABSTRACT

Various embodiments of systems and methods for graphically representing operations associated with a threshold-based monitoring system are described herein. The method involves, receiving a selection of at least two visual objects through a graphical user interface (GUI) of a system. The visual objects each represent a corresponding condition and are graphically represented on the GUI. Further, in an aspect, the method involves receiving an input for a threshold value through the GUI, and comparing the threshold value to a value being monitored. If the monitored value exceeds the threshold value, then a transition from the condition represented by the first visual object to condition represented by the second visual object is graphically indicated on the GUI.

### FIELD

This application relates generally to electronic monitoring systems, and more particularly to a technology for providing a graphical user interface for graphically representing operations associated with a threshold based monitoring system.

### SUMMARY

Various embodiments of systems and methods for graphically representing operations associated with a threshold-based monitoring system are described herein. In an aspect, the method involves, receiving a selection of at least two visual objects through a graphical user interface (GUI) of the monitoring system. The visual objects each represent a corresponding condition and are graphically represented on the GUI. Further, in an aspect, the method involves receiving an input for a first threshold value through the GUI, and comparing the first threshold value to a value being monitored. If the monitored value exceeds the first threshold value, then a transition from the first visual object to the second visual object is graphically indicated. In a further aspect, a selection of a third visual object is received, where the third visual object represents a third condition. In another aspect, the method involves receiving a second threshold value through the GUI. Based on determining that the monitored value exceeds the second threshold value, a transition from the second visual object to the third visual object is graphically indicated on the GUI.

These and other benefits and features of embodiments will be apparent upon consideration of the following detailed description of preferred embodiments thereof, presented in connection with the following drawings.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a flow diagram of a method for graphically representing operations associated with a threshold-based monitoring system on a graphical user interface, according to one embodiment.

FIG. 2 is a flow diagram of a method for graphically representing operations associated with a threshold-based monitoring system on a graphical user interface, according to another embodiment.

FIG. 3 is a block diagram of an exemplary system for generating a graphical representation of operations associated with a threshold-based monitoring system, according to one embodiment.

FIG. 4 illustrates an exemplary graphical user interface showing a threshold-based monitoring system interface, in accordance with an embodiment.

FIG. 5 illustrates an exemplary graphical user interface showing a threshold-based monitoring system interface, in accordance with another embodiment.

FIG. 6 illustrates an exemplary graphical user interface showing a threshold-based monitoring system interface, in accordance with another embodiment.

FIG. 7 illustrates an exemplary graphical user interface showing a threshold-based monitoring system interface, in accordance with another embodiment.

FIG. 8 illustrates an exemplary graphical user interface showing a threshold-based monitoring system interface, in accordance with another embodiment.

FIG. 9 is a block diagram of an exemplary computer system according to one embodiment.

### DETAILED DESCRIPTION

Embodiments of techniques for graphically representing operations associated with a threshold-based monitoring system are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

Electronic control system or threshold-based monitoring system is a system, device, or application that is used to routinely evaluate data, submitted from one or more data sources, against one or more threshold values. In an example, the data to be evaluated may be accessed by reading values from one or more sensors within a system being monitored. Whenever the input data is evaluated using a pre-defined threshold limit, the monitoring system may generate a binary output or a signal, trigger an alert, or perform a subsequent action when some function of the input data exceeds or falls below the pre-defined threshold level. The input data may be received in discreet time periods and the decision to generate an output or trigger an alert is based on the most recent input received. For example, in a quality control system, at each time a measurement is taken and provided to the control system, a signal is generated if the measurement exceeds a pre-defined threshold. However, if the measurement does not exceed the threshold then the process is repeated until such time as the threshold is exceeded.

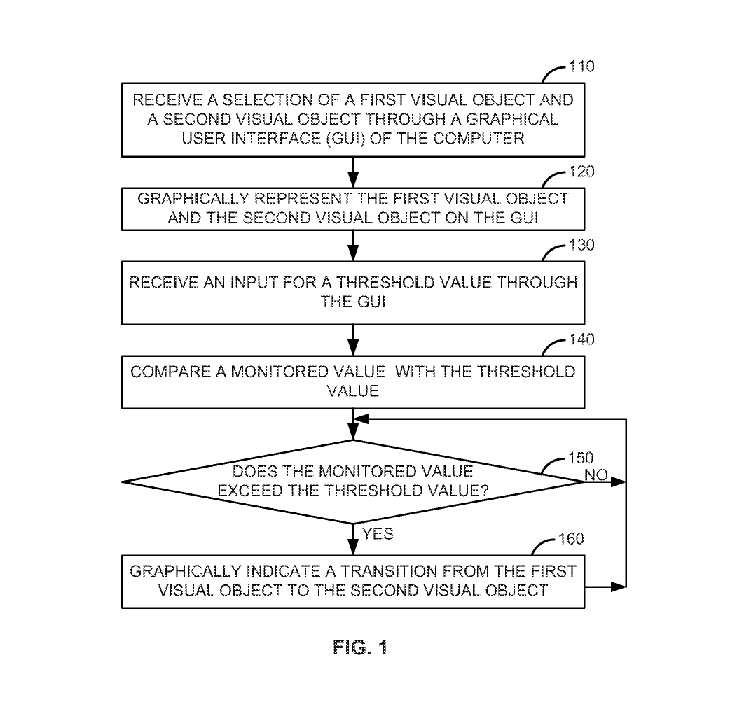

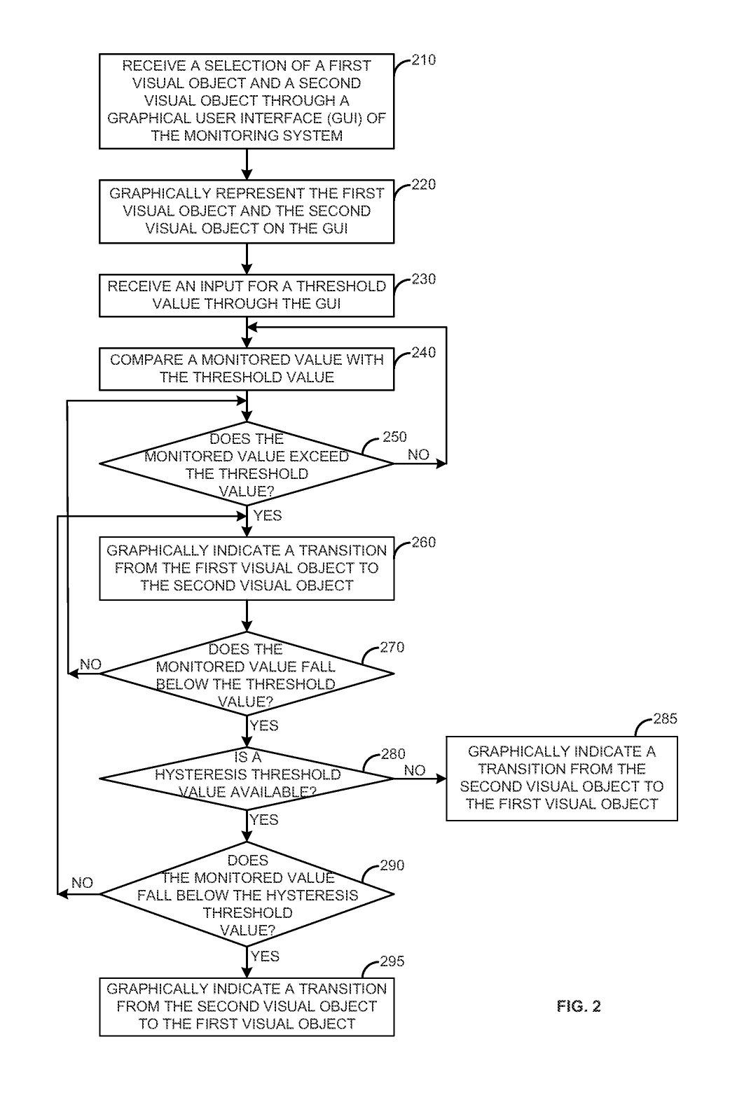

The operations associated with the monitoring system such as providing pre-defined threshold values for evaluating input data, providing a result of the evaluation, and manipulating the given thresholds, can be optimized by graphically representing these operations on a graphical user interface (GUI). The graphical representation is generated as described with reference to FIGS. 1-2.

FIG. 1 illustrates a flow diagram of a method 100 for graphically representing threshold operations associated with a threshold-based monitoring system. The method implemented by a computer or any other electronic device having processing and display capabilities, includes at least the following process illustrated with reference to process blocks 110 to 160. Examples of electronic devices include threshold-based control systems, quality control systems, signal processing systems, data monitoring systems, data analysis systems, etc. The term “threshold operations” as used herein refers to operations such as defining threshold values for evaluating input data, rendering a result of the evaluation, manipulating the given thresholds values, etc. According to an embodiment, the threshold operations are graphically represented on the GUI, in order to enable a user to better view and execute the threshold operations.

The process of graphically representing threshold operations on a graphical user interface (GUI) involves receiving a selection of a first visual object and a second visual object through the GUI of the computer, at process block 110. In an aspect, the first visual object and the second visual object are selected by a user from a set of user-selectable options provided on the GUI. The visual objects each represent a corresponding condition and are graphically represented on the GUI. For example, the visual objects can be any graphical symbol, image, pattern, graph, or any other element having a visually distinct feature. In an example, the first and second visual objects are distinctly colored bands such as “green” and “red” bands respectively.

Further, at process block 120, the first visual object and the second visual object are graphically represented on the GUI, in the given example, the distinctly colored bands are rendered adjacent to each other. The term “adjacent” as used herein refers to being immediately adjoining without intervening space; having a common edge or boundary; touching.

At process block 130, the method involves receiving an input for a threshold value through the GUI. The threshold value may be used to monitor a change in condition such as from “good” to “bad.” in an embodiment, the threshold value is entered into a field that is rendered alongside the common edge of the first and second visual objects. The field for receiving the threshold value may be automatically rendered on the GUI in response to receiving the selection of the first and second visual objects. The input for the threshold value may be a numerical value, a signal, a pattern, a pixel value, or any other quantifiable data. The threshold value is used as a reference against which a monitored value is evaluated. The monitored value is a numerical value, a signal, a pattern, a pixel value, or any other measurable value that is subject to monitoring and/or control.

At process block 140, the monitored value is compared with the threshold value. At decision block 150, it is determined whether the monitored value exceeds the threshold value, if it is determined that the monitored value exceeds the threshold value, then the change in condition from “good” to “bad” may be graphically indicated. At process block 160, a transition from the first visual object to the second visual object is graphically indicated. In the given example, the transition from the “green” band to the “red” band is visually indicated by an arrow key rendered over the common edged of the two bands and pointing in the direction from the “green” band to the “red” band. In another example, the change in condition, i.e., the monitored value exceeding the threshold value may be visually indicated by applying visual effects to the “red” band such as shimmer, flash, blink, etc.

In certain scenarios, multiple thresholds may be set to monitor multiple conditions. For example, a first threshold value may be used to determine a change in condition from “ideal” to “near-ideal” and a second threshold value may be used to determine a change in condition from “near-ideal” to “non-ideal.” In such an embodiment, a user selects three distinctly varying visual objects whereby two fields for receiving the two threshold values are automatically rendered. The three distinctly varying visual objects may each represent a condition such as “ideal,” “near-ideal” and “non-ideal. If a monitored value exceeds the first threshold value then, a change in condition (“ideal” to “near-ideal”) is graphically represented by visually indicating a transition from the first visual object to the second visual object. Similarly, if a monitored value exceeds the second threshold value, then a change in condition (“near-ideal” to “non-ideal”) is graphically represented by visually indicating a transition from the second visual object to the third visual object. On the other hand, when a subsequent evaluation of the monitored value indicates that the monitored value is below the second threshold value, then the change in condition (“non-ideal” to “near-ideal”) is graphically represented by reversing the visual indication. In an example, if the previous condition (“near-ideal” to “non-ideal”) was indicated by an arrow key pointing a transition from the second visual object to the third visual object, then the current condition (“non-ideal” to “near-ideal”) is indicated by the arrow key now pointing a transition from the third visual object to the second visual object.

In certain scenarios, a reversing condition (e.g., “non-ideal” to “near-ideal” or “near ideal” to “ideal”) may be subject to fluctuations, i.e., the change in condition may be subject to sudden changes fluctuating back and forth around a threshold value. In such scenarios, the evaluation of the condition may be erratic and premature. In order to prevent rapid switching between the conditions, as the monitored value drifts around a threshold value, a certain amount of hysteresis (lag) is added to the threshold value in the form of a hysteresis threshold. The hysteresis threshold provides a buffer such that the output of the evaluation reacts slowly. For example, a thermostat controlling a heater may turn the heater on when the temperature drops below 18° C., but not turn it off until the temperature rises above 22° C. In another example, a system that monitors the check-in time of employees coming in to a work shift may be configured to indicate a bad condition when a certain number of employees come either too early (overlap previous shift) or too late (affect productivity) into their shift. In order to monitor employee behavior, a threshold range of 6.30 PM 7.30 PM may be set such that if a certain number of employees come earlier than 6.30 PM or later than 7.30 PM, an indication of a non-ideal condition will be provided by the system. In yet another example, a system monitoring the volume of call flow in a contact center may be configured to indicate a bad condition if the monitored volume of call flow falls within a set range. Based on the set threshold range, the system indicates a “good” condition when the call flow falls below the lower threshold value of the range since only one team of employees is required to handle the call flow. Similarly, the system indicates a “good” condition when the call flow exceeds the upper threshold value of the range since two teams of employees will have sufficient work load. If the call flow volume falls within the set range then the system indicates a “bad” condition since the volume is neither large enough to provide work for two teams nor small enough to be handled by a single team. The process of graphically representing threshold operations including such as applying hysteresis threshold is illustrated with reference to FIG. 2.

The method 200 of graphically representing threshold operations including applying hysteresis threshold, includes at least the following process illustrated with reference to process blocks 210 to 295. The method 200 involves receiving a selection of a first visual object and a second visual object through the GUI of the computer, at process block 210. Further, at process block 220, the first visual object, and the second visual object are graphically represented on the GUI. In an example, the first visual object is a “green” stripe and the second visual object is a “red” stripe. At process block 230, the method 200 involves receiving an input for a threshold value through the GUI. The threshold value may be used to monitor a change in condition such as from “good” to “bad.” In an embodiment, the threshold value is entered into a field that is rendered alongside the common edge of the “green” and “red” stripes.

At process block 240, the monitored value is compared with the received threshold value. At decision block 250, it is determined whether the monitored value exceeds the threshold value. If it is determined that the monitored value exceeds the threshold value, then the change in condition from “good” to “bad” is graphically indicated. At process block 260, a transition from the first visual object to the second visual object is graphically indicated. In the given example, the transition from the “green” stripe to the “red” stripe is visually indicated by an arrow key rendered over the common edged of the two stripes and pointing in the direction from the “green” stripe to the “red” stripe. On the other hand, if at decision block 250, it is determined that the monitored value does not exceed the threshold value then the process continues to compare the monitored value with the threshold value at process block 240.

Subsequent to determining that the monitored value exceeds the threshold value, the process continues to visually indicate the transition from the “green” stripe to the “red” stripe until a change in condition occurs, such as a change in condition from “bad” to “good,”. At decision block 270, the process determines whether the monitored value falls below the threshold value, if it is determined that the monitored value falls below the threshold value, then the process proceeds to determine whether a hysteresis function is enabled. In an embodiment, the hysteresis function may be enabled in response to receiving a selection of corresponding option on the GUI or simply by receiving an input for a hysteresis threshold value. For example, upon receiving a selection of the hysteresis option, a field for receiving the hysteresis threshold value is rendered on the GUI. Also, a visual object is rendered on the GUI to represent the hysteresis condition.

At decision block 280, if it is determined that a hysteresis threshold value is available then the process proceeds to determine whether the monitored value falls below the hysteresis threshold value at decision block 290. However, at decision block 280, if it is determined that the hysteresis function is not enabled, then a change in condition from “bad” to “good” is indicated graphically by indicating a transition from the second visual object to the first visual object, i.e., from “red” stripe to the “green” stripe on the GUI.

At decision block 290, if it is determined that the monitored value falls below the hysteresis threshold value then a transition from the first visual object to the second visual object, i.e., from the “red” stripe to the “green” stripe is graphically indicated. On the other hand, if it is determined that the monitored value does not fall below the hysteresis threshold value then the process continues to indicate a transition from the first visual object to the second visual object. The hysteresis threshold value thus enables a slow response to any rapid change in condition around the threshold value. A change in condition is indicated only when the monitored value falls below the hysteresis threshold value instead of when the monitored value falls below the threshold value.

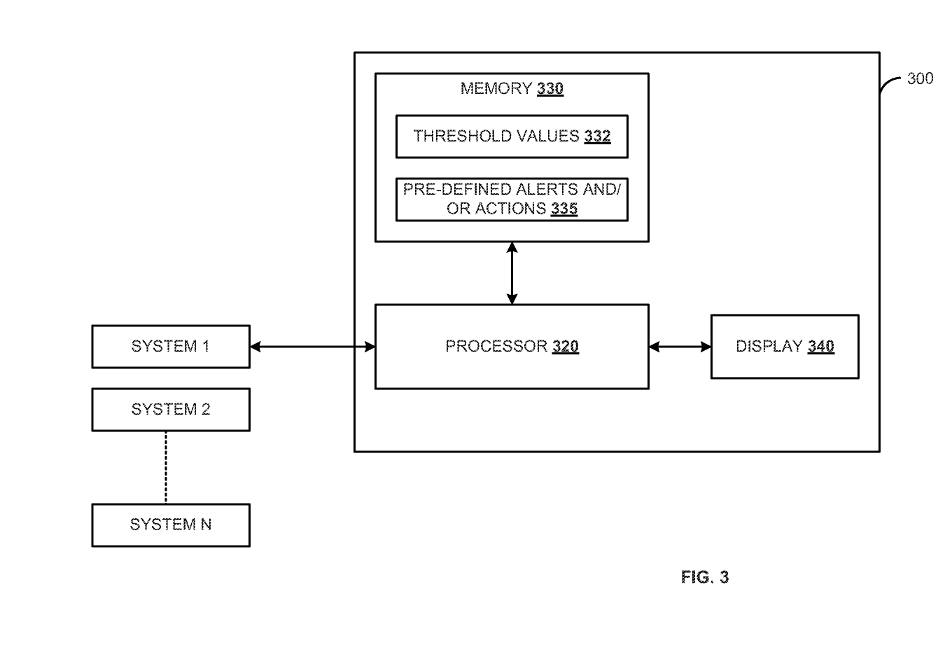

FIG. 3 is a block diagram of an exemplary system 300 for generating an interface for performing threshold-based monitoring functions, according to one embodiment. The system 300 may be communicatively coupled to multiple data source systems 310. The multiple data source systems 310 refer to various functional systems or sensors whose output is subject to monitoring. In an aspect, one or more of the data source systems 310 may also serve as sources of data that enable data storage and/or retrieval. Examples include databases, web applications, web server, a reporting tool, data server etc. Examples of databases include relational, transactional, hierarchical, multi-dimensional (e.g., OLAP), object oriented databases, and the like.

In an embodiment, the system 300 includes a processor 320 that executes software instructions or code comprising for generating a graphical user interface for the threshold-based monitoring tool, stored on a computer readable storage medium, to perform the above-illustrated methods. The system 300 includes a media reader to read the instructions from the computer readable storage medium and store the instructions in storage or in random access memory (RAM). For example, the computer readable storage medium includes executable instructions for performing operations including, but not limited to, invoking the data to be monitored, invoking and displaying a graphical interface on the GUI for receiving one or more threshold values, receiving a selection of one or more visual objects for rendering on the GUI, performing an evaluation of the monitored data based on the threshold values, and visually rendering a result of the evaluation on the GUI. According to an aspect, the memory 330 holds one or more threshold values 332 received via the GUI. The one or more threshold values may be pre-defined as default threshold values which may be manipulated through the GUI. Further, the memory 330 may hold pre-defined alerts or actions 335, which need to be executed based on evaluating the monitored values against the threshold values. The alerts may include a graphical indication, a visual effect, a trigger for an alarm, etc. The pre-defined actions may include generating an output data or signal, switching a toggle, activating a control or a relay, etc.

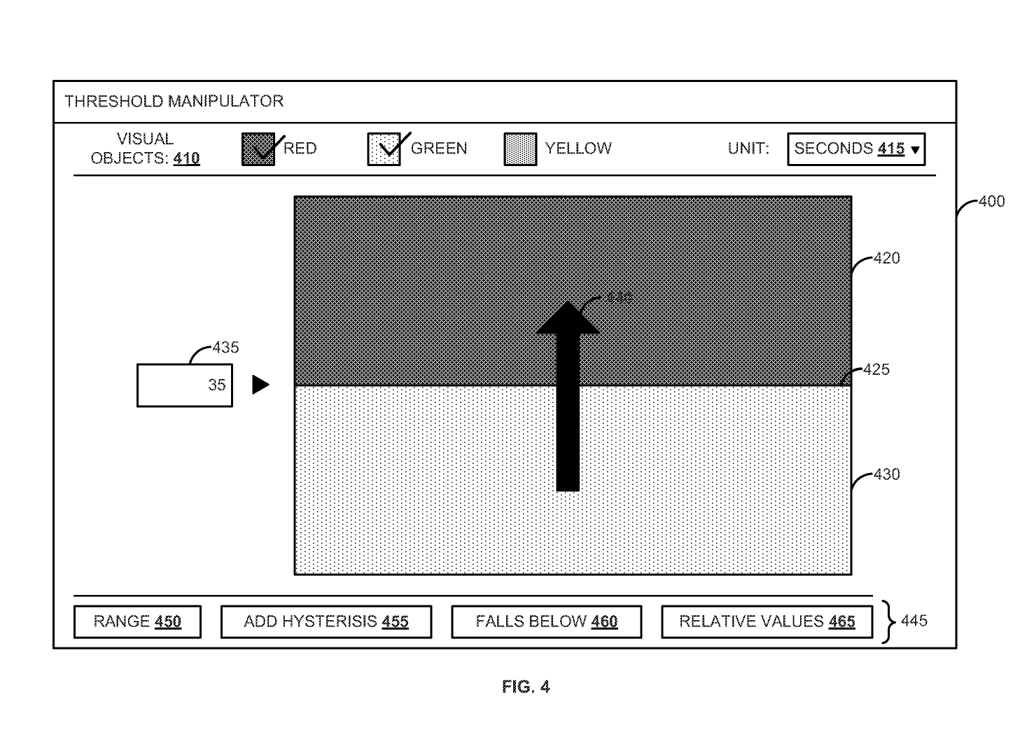

In an embodiment, the processor 320 generates and renders a threshold-based monitoring interface for performing threshold-based monitoring functions on the GUI of the display 340, in response to receiving a selection of one or more visual object through the interface, the processor 320 renders the selected visual objects on the GUI along with fields for receiving the corresponding threshold values. Herein the one or more visual objects represent one or more conditions, whereas the threshold values define the one or more conditions. In response to receiving the threshold values in the corresponding fields, the processor 320 accesses the monitored values directly from the one or more data source systems 310 or invokes the threshold values from the memory 330. The processor 320 then evaluates the monitored values against the threshold values to determine whether the monitored values are within the one or more conditions represented by the visual objects. Based on the evaluation, the processor 320 graphically indicates the status of the monitored values using the visual objects. These and various other embodiments are illustrated with reference to FIGS. 4-9.

FIG. 4 shows a graphical representation of a threshold-based monitoring interface 400 according to some embodiments. The interface 400 includes a visual objects grid 410, a time unit field 415, selected visual objects 420, 430, threshold value field 435, condition indicator 440, and threshold manipulation grid 445.

The visual objects grid 410 provides options for a user to select one or more visual objects for representing a corresponding one or more conditions. The visual objects grid 410 may provide three distinct indicators such as colored or patterned bands/stripes each representing a condition. Upon selecting an option from the visual objects grid 410, a corresponding color or pattern band is rendered on the interface 400. In the given example, upon selecting two colors “red” and “green” the corresponding red and green bands are displayed on the interface 400, each representing a condition. In an embodiment, the green band and the red band are rendered adjacent to each other so as to share a common edge. A change in condition can be indicated by using any visual means to indicate a transition between the green and red band. The visual objects may also be provided in other forms including distinctly patterned objects, shapes, sizes, etc.

In an embodiment, the visual objects 430 and 420 as rendered on the interface 400 may be may be scaled proportional to the threshold value received in the field 435. For example, the green band 430 be scaled to a size representative of the threshold value “35” while the red band 420 may be scaled proportional to a size representative of the monitored value that is in excess of the threshold value, e.g. “5.”

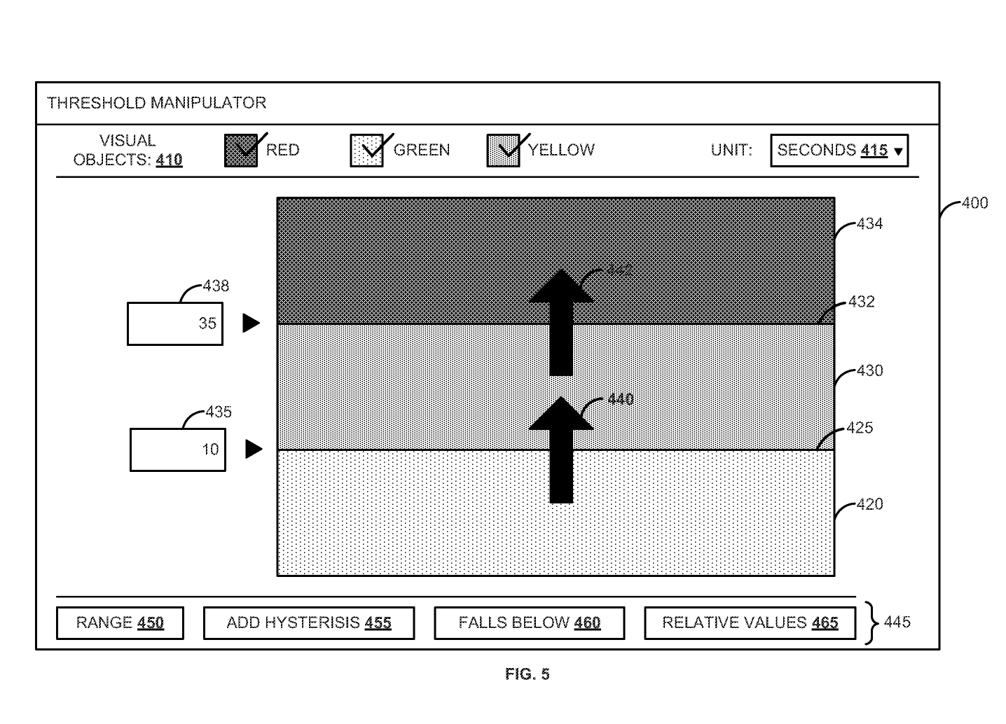

The field 435 for receiving the threshold value may be automatically rendered upon receiving a selection of the visual objects. For example, in response to receiving a selection of two visual objects a field may be rendered alongside the common edge of the two visual objects. In response to receiving a selection of three visual objects, two fields may be rendered alongside the common edge of the first and second visual object and the second and third visual object. As shown in FIG. 5, upon receiving a selection of the visual objects “red,” “green,” and “yellow,” from the visual objects grid 410, the corresponding visual objects are rendered on the interface 400 as distinctly colored bands 420, 430, and 434. In the given example, the visual objects 420, 430, and 434 are rendered adjacent each other so as to share a common edge 425 and 432 between the first and the second and the second and the third visual objects. Also, in the given example, fields 435 and 438 are rendered alongside the visual objects for receiving corresponding threshold values. The condition indicators 440 and 442 visually indicate a current condition of the monitored system determined by evaluating the monitored data using the threshold values as a reference. The monitored value may be evaluated against a threshold at regular time intervals defined via the time unit field 415.

Referring back to FIG. 4, the condition indicator 440 visually indicates a change in condition determined by evaluating a monitored value against the threshold value received in field 435. In the given example, the condition indicator 440 is a direction symbol “↑” that is positioned across the common edge 425 of the two visual objects 420 and 430. The condition indicator 440 is pointed in a direction representing a transition from one visual object to the other depending on the change in condition. For example, based on evaluating the monitored value using the threshold values, if it is determined that the condition is changed from “good” to “bad” then the condition indicator points from visual object 430 to visual object 420, assuming that the visual object 430 represents a good condition and the visual object 420 represents a bad condition. Other visual forms and placement of the condition indicator 440 are well within the scope of this embodiment. In an example, visual effects may be applied to the visual objects themselves to indicate a current condition. In another example, any symbol or shape such as a dot, triangle, or a tick mark may be placed on or beside the visual object representing the current condition.

The user-selectable threshold-manipulation grid 445 provides toggle keys to toggle between two or more options for viewing the threshold monitoring interface. For example, toggle key 450 enables a user to toggle between the option of specifying the threshold value as a range or absolute values. The toggle key 455 provides a toggle between the option of adding hysteresis threshold or not. The toggle key 460 provides a toggle between the threshold evaluation factors exceeds or falls below. The threshold evaluation can be simply reversed by choosing one of the two options using the toggle key 460. The toggle key 465 provides a toggle between the option of specifying the threshold values as relative value, percentile value or absolute values.

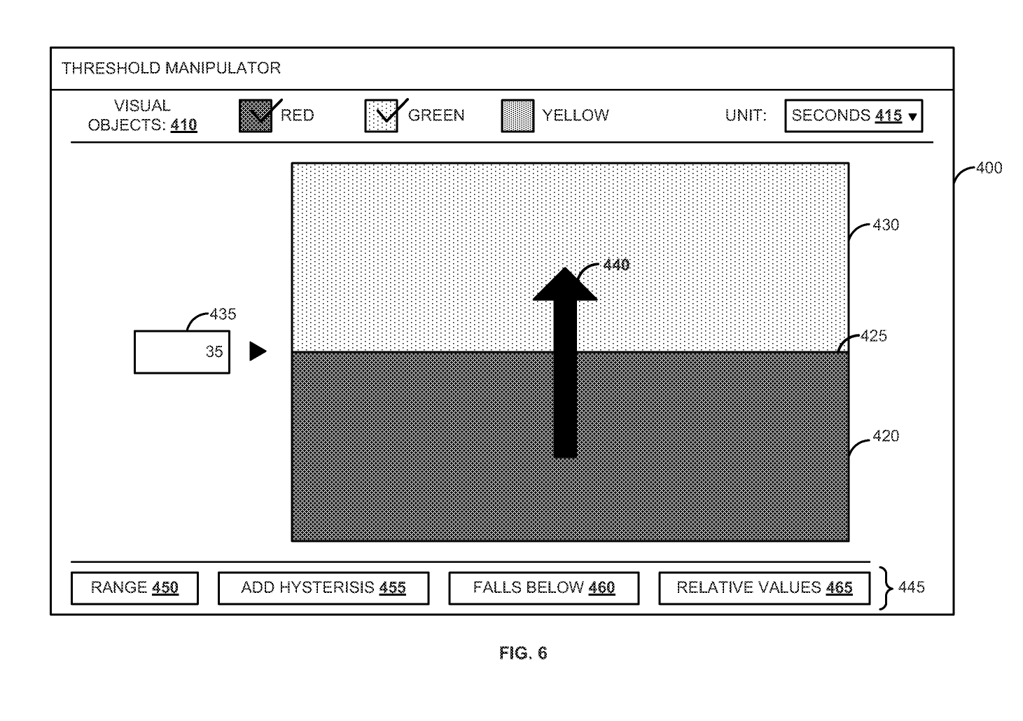

The function provided by the toggle key 460 is illustrated with reference to FIG. 6. As shown in FIG. 6, in response to toggling the evaluation factor from “exceeds” to “falls below” in FIG. 4, the interface 400 is rendered with the position of the visual objects 430 and 420 swapped with each other. This feature is helpful when the conditions are required to be reversed. For example, a certain use case may require a visual indication, whenever a monitored value exceeds a threshold value, in such a scenario, no visual indication will be provided to indicate a transition from a first condition to a second condition as long as the monitored value is below the threshold value. However, certain other use cases may require a visual indication whenever the monitored value falls below the threshold value. In such a scenario, no visual indication will be provided to indicate a transition from a first condition to a second condition as long as the monitored value exceeds the threshold value. For such use cases, a user may simply toggle the evaluation factor using the toggle key 460 to reverse the evaluation factor.

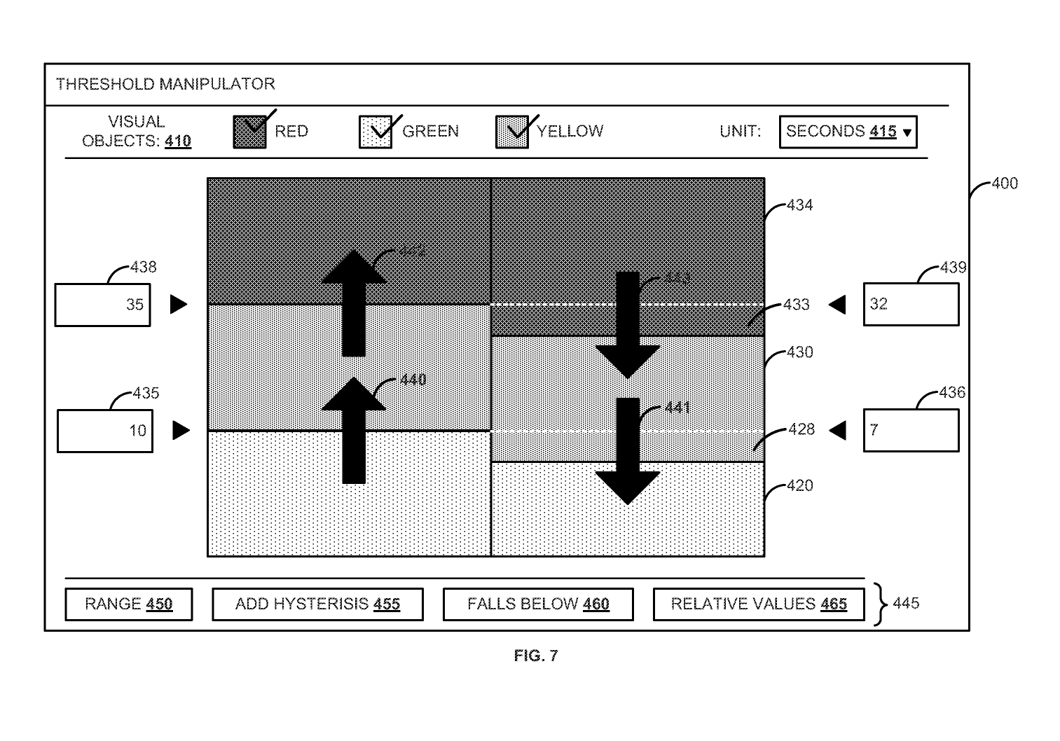

The function provided by the toggle key 455 is illustrated with reference to FIG. 7. The interface 400 includes three visual objects 420, 430, and 434 each representing conditions “ideal,” “near-ideal,” and “non-ideal” respectively. As shown in FIG. 7, in response to receiving a selection via the toggle key 455 for adding hysteresis, the interface 400 automatically adds two additional fields 436 and 439 for receiving the hysteresis threshold values and renders additional visual objects 428 and 433 for the additional conditions defined by the hysteresis threshold values. Upon receiving the hysteresis threshold values, the monitored values are evaluated according to the process described with reference to FIG. 2. For example, the monitored values are compared with the first threshold value “10” received in field 435. If the monitored value exceeds the first threshold value “10” the condition indicator 440 indicates a transition from an “ideal” condition to “near-ideal” condition. If the monitored value further exceeds a second threshold value “35” received in field 438, then a condition indicator 442 indicates a transition from “near-ideal” to “non-ideal.” However, since the option for adding hysteresis is selected, a change in condition from “non-ideal” to “near-ideal” condition or “near-ideal” to “ideal” condition is not indicated as soon as the monitored value falls below the threshold values “35” and “10.” Instead, the monitored values are evaluated using the hysteresis threshold values and a change in condition from “non-ideal” to “near-ideal” or “near-ideal” to “ideal” is indicated only if the monitored value falls below the hysteresis threshold values “32” and “7” received in fields 436 and 439 respectively. For example, a monitored value that falls below threshold value “35” will not trigger a change in condition so long as the monitored value does not fall below the hysteresis threshold value “32.” Similarly, a monitored value that falls below threshold value “10” will not trigger a change in condition so long as the monitored value does not fall below the hysteresis threshold value “7.” If the monitored value falls below the hysteresis value, then the condition indicators 441 and 443 are rendered to graphically indicate a transition between the corresponding conditions.

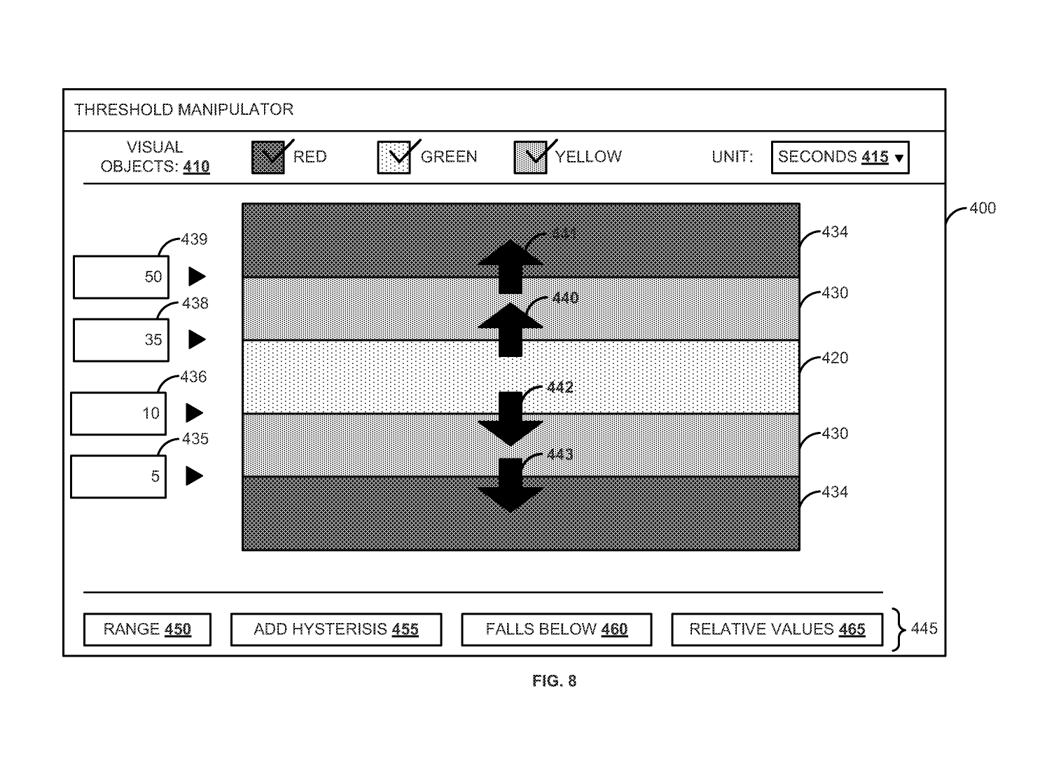

The function provided by the toggle key 450 is illustrated with reference to FIG. 8. FIG. 8 illustrates a graphical user interface 400, where the monitored conditions are defined by a range of threshold values. In the given example, upon receiving a selection of the option to provide a range for evaluating a condition, the interface 400 is automatically rendered with two fields for every visual object being selected. The visual objects however, each represent a single condition. For example, in response to receiving a selection of a first visual object “green” the interface 400 is rendered with a green band 420 with two fields 436 and 438 for receiving threshold values “10” and “35” which define a first range, in response to receiving a selection of a second visual object “yellow” the interface 400 is rendered with a yellow band 430 enclosing the green band 420 along with two fields 435 and 439 for receiving threshold values “5” and “50” which define a second range. In response to receiving a selection of a third visual object “red” the interface 400 is rendered with a red band 434 sandwiching the yellow band 430. The condition represented by the green band 420 is met when the monitored value is within “10” and “35.” Similarly, the condition represented by the yellow band 430 is met when the monitored value falls outside the range, i.e., is above “35” or below “10.” The condition represented by the red band 434 is met when the monitored value is above “50” or below “5.” The change in condition is represented by the corresponding condition indicators 440, 441, 442, or 443.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

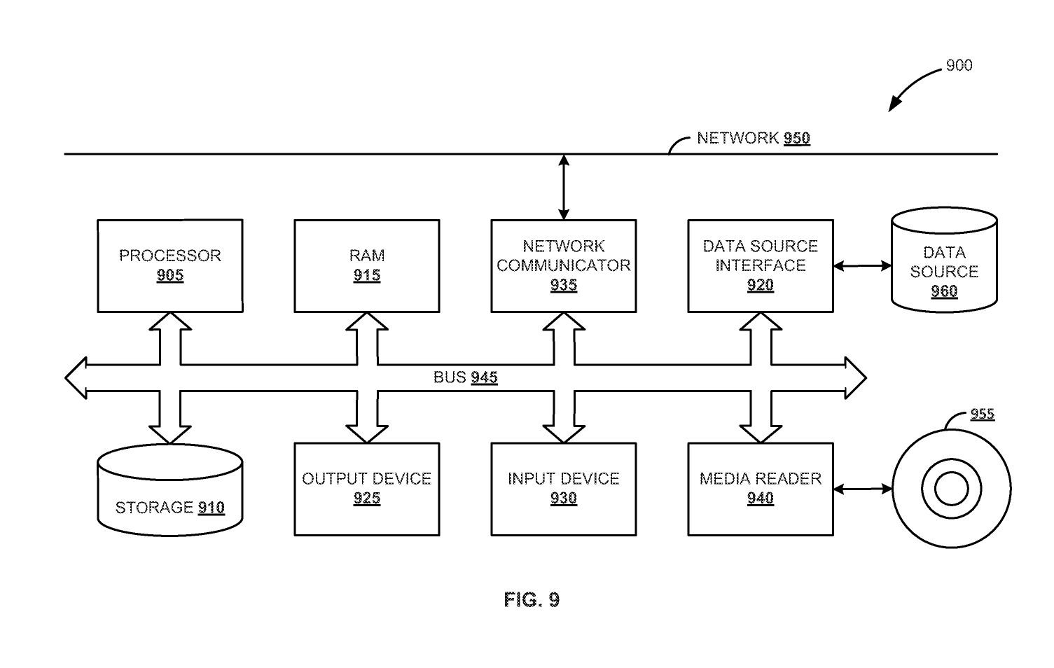

FIG. 9 is a block diagram of an exemplary computer system 900. The computer system 900 includes a processor 905 that executes software instructions or code stored on a computer readable storage medium 955 to perform the above-illustrated methods. The computer system 900 includes a media reader 940 to read the instructions from the computer readable storage medium 955 and store the instructions in storage 910 or in random access memory (RAM) 915. The storage 910 provides a large space for keeping static data where at least some instructions could be stored for later execution. The stored instructions may be further compiled to generate other representations of the instructions and dynamically stored in the RAM 915. The processor 905 reads instructions from the RAM 915 and performs actions as instructed. According to one embodiment, the computer system 900 further includes an output device 925 (e.g., a display) to provide at least some of the results of the execution as output including, but not limited to, visual information to users and an input device 930 to provide a user or another device with means for entering data and/or otherwise interact with the computer system 900. Each of these output devices 925 and input devices 930 could be joined by one or more additional peripherals to further expand the capabilities of the computer system 900. A network communicator 935 may be provided to connect the computer system 900 to a network 950 and in turn to other devices connected to the network 950 including other clients, servers, data stores, and interfaces, for instance. The modules of the computer system 900 are interconnected via a bus 945. Computer system 900 includes a data source interface 920 to access data source 960. The data source 960 can be accessed via one or more abstraction layers implemented in hardware or software. For example, the data source 960 may be accessed by network 950, in some embodiments the data source 960 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer-implemented method of graphically representing threshold operations, the method comprising:
receiving a selection of a first visual object and a second visual object through a graphical user interface (GUI) of the computer, wherein the first visual object represents a first condition and the second visual object represents a second condition;
graphically representing the first visual object and the second visual object on the GUI;
receiving an input for a threshold value through the GUI; and
upon determining that a monitored value exceeds the threshold value, graphically indicating a transition from the first visual object to the second visual object on the GUI.

2. The method of claim 1, wherein graphically representing the first visual object and the second visual object on the GUI comprises rendering the first visual object and the second visual object adjacent to each other so as to have a common edge.

3. The method of claim 1, wherein the first visual object represents an ideal condition and the second visual object represents a non-ideal condition.

4. The method of claim 1, wherein the first visual object and the second visual object are rendered as visually distinct graphical representations on the GUI.

5. The method of claim 1, wherein the first visual object and the second visual object are rendered as distinctly colored bands on the GUI.

6. The method of claim 1, wherein graphically indicating the transition from the first visual object to the second visual object on the GUI comprises providing a direction key indicating a direction of transition between the first visual object and the second visual object.

7. A computer-implemented method of graphically representing threshold operations in a threshold monitoring system, the method comprising:
receiving a selection of a first visual object and a second visual object through a graphical user interface (GUI) of the monitoring system, wherein the first visual object represents a first condition and the second visual object represents a second condition;
graphically representing the first visual object and the second visual object on the GUI;
receiving an input for a threshold value through the GUI;
comparing the threshold value with a monitored value;
upon determining that the monitored value exceeds the threshold value, graphically indicating a transition from the first visual object to the second visual object on the GUI;
upon determining that the exceeded monitored value falls below the threshold value, determining whether a hysteresis threshold value is received through the GUI;
upon determining that the hysteresis threshold value is not received, graphically indicating a transition from the second visual object to the first visual object;
upon determining that the hysteresis threshold value is received, determining whether the monitored value falls below the hysteresis threshold value, wherein the hysteresis threshold value is less than the threshold value; and
graphically indicating a transition from the second visual object to the first visual object only upon determining that the monitored value falls below the hysteresis threshold value.

8. A computer-implemented method of graphically representing threshold operations in a threshold monitoring system, the method comprising:
receiving a selection to set a threshold range;
receiving a selection of a first visual object and a second visual object through a graphical user interface (GUI) of the monitoring system, wherein the first visual object represents a first condition and the second visual object represents a second condition;
graphically representing the first visual object and the second visual object on the GUI;
receiving a first threshold value and a second threshold value defining a first threshold range;
upon determining that a monitored value exceeds the first threshold value or falls below the second threshold value, graphically indicating a transition from the first visual object to the second visual object on the GUI.

9. The method of claim 8, wherein graphically representing the first visual object and the second visual object on the GUI comprises rendering the first visual object enclosed within the second visual object.

10. An article of manufacture, comprising:
a non-transitory computer readable storage medium having instructions which when executed by a computer causes the computer to:
receive a selection of a first visual object and a second visual object through a graphical user interface (GUI) of the monitoring system, wherein the first visual object represents a first condition and the second visual object represents a second condition;
graphically represent the first visual object and the second visual object on the GUI;
receive an input for a threshold value through the GUI;
compare the threshold value with a monitored value;
upon determining that the monitored value exceeds the threshold value, graphically indicate a transition from the first visual object to the second visual object on the GUI;
upon determining that the exceeded monitored value falls below the threshold value, determine whether a hysteresis threshold value is received through the GUI;
upon determining that the hysteresis threshold value is not received, graphically indicate a transition from the second visual object to the first visual object;
upon determining that the hysteresis threshold value is received, determine whether the monitored value falls below the hysteresis threshold value, wherein the hysteresis threshold value is less than the threshold value; and
graphically indicate a transition from the second visual object to the first visual object only upon determining that the monitored value halls below the hysteresis threshold value.

11. The article of manufacture in claim 10, wherein the first visual object and the second visual object are rendered adjacent to each other so as to have a common edge.

12. The article of manufacture in claim 10, wherein the first visual object represents an ideal condition and the second visual object represents a non-ideal condition.

13. The article of manufacture in claim 10, wherein the first visual object and the second visual object are rendered as distinctly colored bands on the GUI.

14. The article of manufacture in claim 10, wherein the transition from the first visual object to the second visual object is graphically indicated on the GUI using a direction key indicating a direction of transition between the first visual object and the second visual object.

15. The article of manufacture in claim 10, wherein the hysteresis threshold value is graphically represented using a third visual object adjoining the first visual object and the second visual object.

16. The article of manufacture in claim 10, wherein the threshold value is expressed as a percentile value.

17. The article of manufacture in claim 10, wherein the input for the threshold value is received via one or more fields in the GUI.

18. The article of manufacture in claim 10, wherein the first visual object and second visual object are selected from a set of user-selectable options in the GUI.

19. A system operating in a communication network, comprising:
one or more data source systems; and
a computer comprising a memory to store a program code, and a processor to execute the program code to:
receive a selection of a first visual object and a second visual object through a graphical user interface (GUI) of the monitoring system, wherein the first visual object represents a first condition and the second visual object represents a second condition;
graphically represent the first visual object and the second visual object on the GUI;
receive an input for a threshold value through the GUI;
compare the threshold value with a monitored value;
upon determining that the monitored value exceeds the threshold value, graphically indicate a transition from the first visual object to the second visual object on the GUI;
upon determining that the exceeded monitored value falls below the threshold value, determine whether a hysteresis threshold value is received through the GUI;
upon determining that the hysteresis threshold value is not received, graphically indicate a transition from the second visual object to the first visual object;
upon determining that the hysteresis threshold value is received, determine whether the monitored value falls below the hysteresis threshold value, wherein the hysteresis threshold value is less than the threshold value; and
graphically indicate a transition from the second visual object to the first visual object only upon determining that the monitored value falls below the hysteresis threshold value.

20. The system of claim 19, wherein the monitored value is received from the one or more data source systems.
